(19) United States
(12) Patent Application Publication
(10) Pub. No.: US 2026/0125869 A1
(43) Pub. Date: May 7, 2026

(54) Auxiliary Facilities and Method for Fish Resource Recovery in Open Water Diversion Channel

(71) Applicant: CHINA INSTITUTE OF WATER RESOURCES AND HYDROPOWER RESEARCH, BEIJING (CN)

(72) Inventors: Rui HAN, BEIJING (CN); Li ZENG, BEIJING (CN); Qiang ZHANG, BEIJING (CN); Ranran CAO, BEIJING (CN); Jia YANG, BEIJING (CN); Wei BAI, BEIJING (CN); Yijun ZHAO, BEIJING (CN); Ping JI, BEIJING (CN)

(73) Assignee: CHINA INSTITUTE OF WATER RESOURCES AND HYDROPOWER RESEARCH, BEIJING (CN)

(21) Appl. No.: 19/265,366

(22) Filed: Jul. 10, 2025

(30) Foreign Application Priority Data
Nov. 7, 2024 (CN) 202411583273.3

(51) Int. Cl. E02B 8/08; A01K 61/10

(52) U.S. Cl. CPC E02B 8/085; A01K 61/10

(57) ABSTRACT

The present invention relates to an auxiliary method and facility for fish resource recovery in an open water diversion channel, which includes: an inlet of the attraction channel arranged on a side wall of the open water diversion channel, a slope provided inside the attraction channel, wherein a lower end of the slope is located inside the open water diversion channel, and a higher end of the slope is located outside the open water diversion channel, an attracted water flow is arranged at the higher end of the slope to guide fish into the attraction channel and an outlet of the attraction channel is connected to a still water zone, wherein the still water zone is provided with a release device. The present invention effectively guides a significant number of fish that have mistakenly entered the open water diversion channel out of the channel through attracted attraction. This approach not only protects fish resources but also prevents channel blockages caused by massive fish intake, thereby avoiding power plant shutdown incidents, thus preventing substantial economic losses and, more importantly, ensures the operational safety of the power plant.

### CROSS-REFERENCE TO RELATED APPLICATION

This application claims the priority benefit to Chinese application No. 202411583273.3 filed on Nov. 7, 2024, the entirety of which is hereby incorporated by reference and made a part of this specification.

### TECHNICAL FIELD

The present invention relates to an auxiliary facility and method for fish resource recovery in an open water diversion channel, which pertains to hydraulic engineering and methods for protecting fish ecology during power plant water intake processes. It serves as a measure to reduce the impact of open channel water intake on fish resources and mitigate risks associated with water intake entrainment, impingement, and nuclear power cold source hazards, thereby enhancing the operational safety and environmental friendliness of water intake projects. This invention provides an environmentally friendly auxiliary facility and method for fish resource recovery in open water diversion channels that considers fish behavioral characteristics and water intake flow field distribution patterns.

### BACKGROUND ART

In recent years, multiple incidents of nuclear power plant water intake blockages have occurred, caused by organisms including commercial fish species, jellyfish, and algae. These incidents have forced nuclear power plants to shut down reactors, cease operations, or reduce power output, resulting in significant economic losses and, more importantly, posing serious threats to nuclear power operational safety. Meanwhile, against the backdrop of vigorous ecological civilization development, the ecological impact of nuclear operation has become a key focus in industry development. The adverse effects of nuclear power water intake on marine organisms, particularly fish resources, have hindered the harmonious development between nuclear power and marine environments. Research on the impact of the nuclear power water intake on fish began in the 1970s. Studies indicate that fish entering nuclear power water intake systems exhibit low survival rates and high mortality, directly causing fish resource losses from nuclear power water intake. For instance, the Bay Shore Nuclear Power Plant in the United States, with a total operational capacity of 631 MW and water intake of 33 m³/s, the results from monitoring show the plant entrains approximately 4.6×10⁷ adult fish annually, predominantly Anomalopidaes and gizzard shads. Current mitigation measures primarily include reducing intake flow velocity, decreasing water intake volume, and installing barrier nets around intake structures. However, no corresponding facilities have been implemented within open water diversion channels to recover fish resources that enter the open water diversion channel and minimize water intake impacts on the fish.

While ensuring cold source safety, nuclear power plants must protect marine organisms during water intake processes and reduce biologically attracted losses. At present, most existing nuclear power plants neglect water intake impacts of the water intake facilities on fish. Some plants have gradually begun recording entrained fish biomass data, but none have constructed fish resource recovery facilities. There is an urgent need to incorporate fish resource recovery facilities in water intake systems. How to recover and protect fish entering the open water diversion channels, reduce intake impingement, and prevent intake blockages remains a critical problem to be solved.

### SUMMARY OF THE INVENTION

In order to overcome the problems of the prior art, the present invention provides an auxiliary facility and method for fish resource recovery in an open water diversion channel. The facility and method involve providing an attraction channel and attracting water flow on one side of the open water diversion channel inlet to attract fish that have mistakenly entered the open water diversion channel into a specially designed attraction channel, then guide them through the channel to a still water zone outside the open water diversion channel. Subsequently, the fish in the still water zone are either guided or captured and are released into natural waters.

An objective of the present invention is achieved as follows: an auxiliary facility for fish resource recovery in an open water diversion channel, which includes: an inlet of the attraction channel arranged on a side wall of the open water diversion channel, a slope provided inside the attraction channel, wherein a lower end of the slope is located inside the open water diversion channel, and a higher end of the slope is located outside the open water diversion channel, an attracted water flow is arranged at the higher end of the slope to guide fish into the attraction channel and an outlet of the attraction channel is connected to a still water zone, wherein the still water zone is provided with a release device, an interception net arranged downstream of the inlet of the attraction channel.

Further, the direction of the attracted water flow forms an angle of 90 degrees or greater with the flow direction in the open water diversion channel.

Further, the open water diversion channel comprises two parallel side walls forming a straight channel section, a 90-degree elbow is provided at the end of the straight channel section, making the open water diversion channel inlet parallel to one side wall, the inlet of the attraction channel is arranged on the side of the recirculation zone in the open water diversion channel at a position 2-3 inlet widths away from the open water diversion channel inlet, and the attracted water flow perpendicular to the open water diversion channel can penetrate through the recirculation zone in the open water diversion channel.

Further, the slope gradient of the attraction channel is less than 1:10, the width should not exceed 5 m, and the water depth should not be less than 0.5 m.

Further, an attracted water flow rate is 1/15 of the water flow rate in the open water diversion channel.

Further, the release device is a fish guidance channel.

Further, the release device is a fishing trap.

An auxiliary method for fish resource recovery in an open water diversion channel using the above facility, the steps of the method being as follows:
step 1: establishing a water intake zone three-dimensional flow field model: establishing the water intake zone three-dimensional flow field model which includes the open water diversion channel, acquiring topography of the water intake zone, ambient flow conditions, shoreline characteristics, as well as the design dimensions, water intake flow rate, intake flow velocity, and intake depth of the open water diversion channel, establishing a water intake flow field model, dividing computational grids, determining boundary conditions and initial conditions for flow field simulation, and selecting appropriate computational parameters to simulate flow field variations including the open water diversion channel and its affected water area; wherein the governing equations for flow field computation are as follows:

$$∇ \cdot u = 0$$

$$\frac{\partial u}{\partial t} + u \cdot ∇ u = - \frac{∇ p}{ρ} + \frac{1}{ρ} ∇ \cdot ( {μ}_{eff} ∇ u ) - \frac{2}{3} ∇ \cdot ( kI )$$

$$\frac{\partial }{\partial t} ( ρ k ) + ∇ \cdot ( ρ ku ) = ∇ \cdot ( {α}_{k} {μ}_{eff} ∇ k ) + {G}_{k} - ρε$$

$$\frac{\partial }{\partial t} ( ρε ) + ∇ \cdot ( ρε u ) = ∇ \cdot ( {α}_{ε} {μ}_{eff} ∇ ε ) + {C}_{1 ε} \frac{ε}{k} {G}_{k} - \frac{ρ {C}_{2 ε} {ε}^{2}}{k}$$

wherein u is a time-averaged velocity, t is time, p is pressure, ρ is water density, μ_{eff} is a turbulent effective viscosity, k is turbulent kinetic energy, I is second-order unit tensor, αₖ is a turbulent kinetic energy Prandtl number, ε is a turbulent dissipation rate, αε is a turbulent dissipation rate Prandtl number, Gₖ is a turbulent kinetic energy generation term caused by an average velocity gradient, and C_{1ε} and C_{2ε} are constant coefficients;
step 2: validating the flow field model based on physical model experiments: constructing a corresponding geometrically scaled physical model indoors, and measuring the flow velocity and direction at characteristic cross-sections or points within the attraction channel, comparing these measurements with simulation results of the mathematical model for validation, wherein if the calculated values align well with the measured values, the established mathematical model can reflect basic characteristics of flow field distribution in the open water diversion channel, based on this, the location where fish resource recovery facilities are located in the open water diversion channel, as well as the water flow rate and configuration dimensions of the attracted water flow can be determined;
step 3: selecting the location of the attraction channel: based on flow field distribution analysis and considering swimming capabilities and behavioral characteristics of fish entering the channel, locating the inlet of the attraction channel near a bank in a low-velocity area at the center of a recirculation zone where recirculation is relatively weak, wherein the outlet of the attraction channel is placed in a near-bank still water zone outside the channel where the water flow is slow and stable, serving as a temporary holding area for fish before release;
step 4: determining configuration, dimensions, and attracted water flow rate of the attraction channel: based on flow field distribution analysis, combined with the swimming capabilities and behavioral characteristics of fish entering the channel, as well as the flow velocity and flow patterns within the attraction channel, comprehensively determining the configuration, dimensions, and the attracted water flow rate of the attraction channel;
step 5: modifying a physical model experiment for further flow field verification: according to the recommended attraction channel design proposed in step 4, modifying the physical model in step 2 by adding the attraction channel and a water supply system at the corresponding location in the channel, then conducting the physical model experiment to further study and analyze the flow field, and verifying suitability of the fish resource recovery facilities;
step 6: providing auxiliary interception facilities:
based on flow field analysis results in the channel, installing an auxiliary interception net downstream of the inlet of the attraction channel in an area with relatively uniform and low-velocity flow, wherein the interception net spans the entire cross-section, encouraging fish to more easily find the inlet of the attraction channel while swimming along the net; and
step 7: fish attraction and recovery process: activating the attraction channel, creating a jet flow from the recirculation zone to a main flow zone at the inlet of the attraction channel; utilizing fish's innate tendency to swim against currents and support of auxiliary facilities, guiding the fish in both the main flow and recirculation zones toward the inlet of the attraction channel, wherein the slope within the attraction channel generates a stable, uniformly graded reverse flow field, attracting fish to swim upstream to the still water zone at the outlet of the attraction channel, then the fish in the still water zone are released into natural waters outside the channel via the release device.

The advantages and benefits of the present invention are as follows: an attraction channel and attracting water flow are provided on one side of the open water diversion channel inlet to attract fish that have mistakenly entered the open water diversion channel into a specially designed recovery auxiliary facility which then guide them through the channel to a still water zone outside the open water diversion channel. Subsequently, the fish in the still water zone are either guided or captured and are released into natural waters outside the open channel. The present invention effectively guides a significant number of fish that have mistakenly entered the open water diversion channel out of the channel through attracted attraction. This approach not only protects fish resources but also prevents channel blockages caused by massive fish intake, thereby avoiding power plant shutdown incidents, thus preventing substantial economic losses and, more importantly, ensures the operational safety of the power plant.

### BRIEF DESCRIPTION OF THE DRAWINGS

The present invention is further illustrated by the following figures and examples.

FIG. 1 is a schematic plan view of a facility for recovery according to Embodiment 1 of the present invention;

FIG. 2 is a schematic structural diagram showing an elevation of an attraction channel of a facility for recovery according to Embodiment 1 of the present invention, which is enlarged in the direction of A-A in FIG. 1;

FIG. 3 is a schematic diagram showing an angle between an attracted water flow and an open channel water flow in a facility for recovery according to Embodiment 2 of the present invention, which is an enlarged view of point C in FIG. 1;

FIG. 4 is a flow field distribution diagram of a facility for recovery according to Embodiment 3 of the present invention; and

FIG. 5 is a flow chart of a method according to Embodiment 8 according to the present invention.

### DETAILED DESCRIPTION OF THE INVENTION

### Embodiment 1

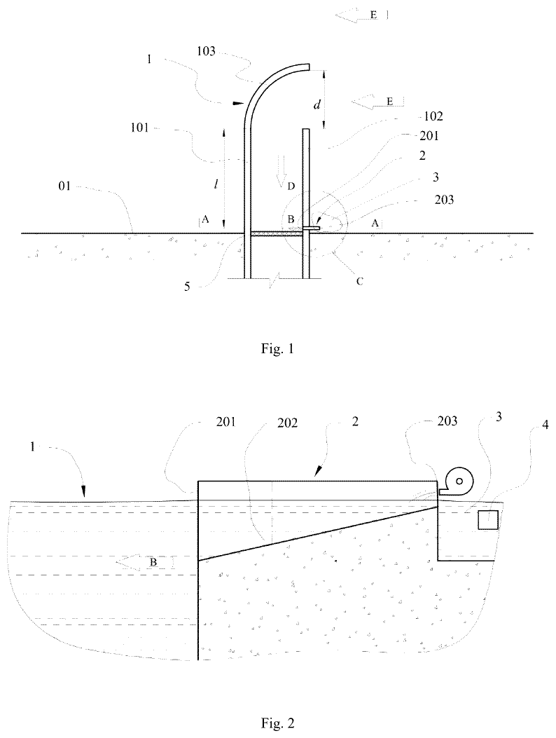

The present embodiment is an auxiliary facility for fish resource recovery in an open water diversion channel, as shown in FIG. 1. The present embodiment includes: an inlet 201 of the attraction channel 2 arranged on a side wall of an open water diversion channel 1, a slope 202 is provided inside the attraction channel, where a lower end of the slope is inside the open water diversion channel, and a higher end of the slope is located outside the open water diversion channel; an attracted water flow B flowing into the attraction channel is arranged at a high end of the slope, and the flow direction of the attracted water flow B is perpendicular or nearly perpendicular to the water intake main flow direction D in the open water diversion channel; an outlet 203 of the attraction channel is connected to a still water zone 3, wherein the still water zone is provided with a release device 4, an interception net 5 arranged downstream of the inlet of the attraction channel.

The basic idea of the present embodiment is: in order to solve the problem of fish resource recovery in the open water diversion channel, reduce the impact of power plant water intake operation on fish resources, and realize the ecological operation of power plant water intake. The present embodiment strives to create flow patterns within the open channel that facilitate fish entering the channel to discover and access the attraction channel. For example: utilizing innate rheotaxis (tendency to swim against currents) of the fish, outflow of the attraction channel creates a counter-current environment, preferably directly connected to the main flow of the open channel to better guide fish toward and into the attraction channel; additionally, an auxiliary interception net should be installed downstream of the inlet of the attraction channel at a cross-section with relatively uniform flow (and lower velocity), helping fish locate the attraction channel while swimming along the net, which means the flow near the outlet of the attraction channel should exhibit a counter-current characteristic with velocities matching fish preference. To effectively attract fish to aggregate near the inlet of the attraction channel, the attraction channel must employ a sufficient attracted water flow rate, which consequently exerts certain impacts on the economic aspects of project operation.

The open water diversion channel is constructed along the shore and comprises two parallel side walls. The head of the channel typically incorporates a curved section to accommodate the ambient water flow. As shown in FIG. 1, the ambient water flow follows the shoreline 01 (in the direction of arrow E in FIG. 1). The curved section of the channel's side walls forms a 90-degree bend, representing a relatively typical configuration for the inlet of an open channel. When the power plant is constructed along a river and uses river water as the cooling source, the flow E is unidirectional. When the power plant is built along the coast and uses seawater as the cooling source, the direction of the ambient water flow becomes a bidirectional alongshore reciprocating tidal current, which means there exists flow in the E direction (flood tide) as well as ambient flow in the opposite direction of E (i.e., ebb tide). However, due to the blocking effect of the open channel 103 structure on the external ambient flow, the flow field distribution patterns in the straight section of the channel remain similar under conditions of flood tide, ebb tide, and riverine environments. Specifically, the distribution patterns of the water intake main flow zone and the recirculation zone within the open channel remain consistent.

The location of the attraction channel shall be determined through physical modeling and computational hydrodynamic mathematical model flow field analysis. As shown in FIG. 1 for the elbow-shaped open channel, the attraction channel may be positioned relatively close to the shore near the channel inlet. Flow field analysis indicates this area constitutes a recirculation zone with relatively low average flow velocity, where the addition of external water flow can readily establish a jet environment attractive to fish, thereby facilitating the aggregation of fish toward the inlet of the attraction channel.

The attraction channel incorporates a sloped passage designed to attract fish to swim against currents into the still water zone. As illustrated in FIG. 2, the lower end of the slope serves as the fish inlet while the higher end functions as the exit. This configuration requires water flow along the slope from high to low elevation, generating a jet flow directed toward the open channel (indicated by arrow B in FIGS. 1 and 2). To produce this jet flow, artificial means such as pumps must be employed to extract the attraction flow from the downstream end of the open channel and inject water into the attraction channel, thereby creating attracted water flow. When this attracted water flow enters the open channel through the attraction channel, it forms a transverse current penetrating from the recirculation zone to the main flow (arrow D in FIG. 1). Typically, the attracted water flow rate may be approximately one-fifteenth of the water flow rate of the open water diversion channel, or slightly greater. The attracted water flow entering the open channel may be oriented perpendicular to the main intake flow direction for optimal guidance effect, or may be angled toward the main flow direction, preferably maintaining an angle close to 90° as excessive deviation may diminish the fish attraction effectiveness. The outlet of the attraction channel is specifically designed with a still water basin.

The release device may consist of specialized equipment for fish capture, serving to concentrate and capture fish entering the still water zone before returning them to natural waters to maintain ecological balance. Alternatively, dedicated fish pumps may be utilized to transport fish back to natural waters.

A full-cross-section interception facility is installed in the open channel downstream of the inlet of the attraction channel, serving to intercept and assist fish in aggregating toward the inlet of the attraction channel. The interception net guides fish that miss the inlet of the attraction channel to swim along the net and aggregate toward the inlet of the attraction channel, ultimately entering the attraction channel. While the interception net is standard equipment in open water diversion channels, they serve the additional specific purpose in the present embodiment of intercepting fish that bypass the attraction channel and directing them to swim along the net toward the inlet of the attraction channel under the guidance of counter-current flow.

It should be noted that the attraction channel functions as a passage to guide mistakenly entered fish out of the open water diversion channel, which may be known as a “fishway,” and differs fundamentally from traditional fish passages designed to address dam-blocked migratory routes, hence it refers to the “attraction channel” in the present embodiment. The attraction channel primarily considers fish behavior, thus the definitions of “inlet” and “exit” are determined by fish swimming direction. The end where fish enter the attraction channel is known as the inlet, while the opposite end is the exit. This terminology is opposite to the water flow direction within the attraction channel, water flows out at the inlet (lower end of slope) and in at the exit (higher end of slope).

The “left” and “right” described in the present embodiment and in the following embodiments are determined according to the direction of water flow in hydraulics, i.e., in hydraulics, the description to the “left” and “right” of the present embodiment still follows this principle with the downstream of the water flow being the positive direction and the left hand being the left bank of the river and the right hand being the right bank of the river.

### Embodiment 2

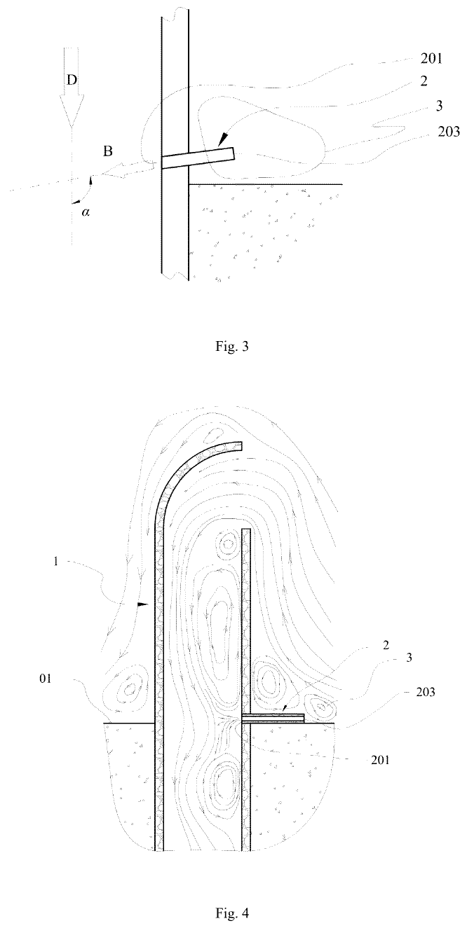

The present embodiment represents an improvement over Embodiment 1 and is a refinement of Embodiment 1 with respect to the attracted water flow. The angle α between the direction B of the attracted water flow and the flow direction D within the open water diversion channel described in the present embodiment is greater than or equal to 90 degrees, as shown in FIG. 3.

The jet direction of the attracted water flow is primarily determined by the orientation of the outlet of the attraction channel. Therefore, once the attraction channel is constructed, the direction of the attracted water flow is essentially fixed. Consequently, preliminary experiments should be conducted for specific fish species of certain sizes to determine the optimal angle.

### Embodiment 3

The present embodiment represents an improvement over the above-described embodiments and is a refinement of the above-described embodiments with respect to the open water diversion channel. The open water diversion channel described in the present embodiment comprises two parallel side walls 101 and 102 forming a straight channel section, wherein the end of the straight channel section is provided with a 90-degree elbow 103 (a left side wall actually connected to the elbow in FIG. 1), making the open water diversion channel inlet parallel to one side wall, and the 90-degree elbow enables the water flow entering the open water diversion channel to form a main flow zone and a recirculation zone in the straight channel section; the inlet of the attraction channel is arranged on a side/of the recirculation zone in the open water diversion channel at a position 2-3 inlet widths away from the open water diversion channel inlet, and the attracted water flow perpendicular to the open water diversion channel can penetrate through the recirculation zone in the open water diversion channel. As shown in FIG. 1, d is the width of the inlet of the open water diversion channel, and/is the distance between the inlet of the attraction channel and the inlet of the open water diversion channel, for example: the inlet width is d=200 m, and the channel is provided in the middle of the open channel at a position of about/=400 m.

The present embodiment adopts the open water diversion channel with a 90-degree elbow at the head end as shown in FIG. 1. Through the construction of a 1:100 scale physical model and computer flow field simulation model, the internal and external water flows of such channel are simulated to generate the flow field distribution diagram inside and outside the channel, as shown in FIG. 4. By analyzing the flow field distribution diagram, the attraction channel is arranged on the left side of the open water diversion channel near the shore area. This area is located within the recirculation zone on the left side of the channel interior, with the inlet of the attraction channel positioned in the shore-side central area of the recirculation zone. The flow velocity in the recirculation zone is relatively weak, while the right side constitutes the main flow zone with higher velocity and stable flow direction that is unsuitable for fish residence. Fish with certain swimming capability may swim outward along the main flow against the current driven by their rheotaxis behavior, while fish with relatively weaker swimming ability tend to move in velocity-preferable areas near the recirculation zone based on their velocity selection preference. Therefore, the attraction channel is installed near the shore in the weak central area of the recirculation zone, with a certain water flow rate set upstream of the channel to create a counter-current environment with more suitable flow velocity for fish. This attracts fish to actively swim toward this area, achieving the purpose of aggregating fish here. Combined with subsequent collection measures (such as fish pumps), fish are guided out of the channel interior, thereby reducing marine organism damage caused by entrainment and impingement, and consequently protecting marine biological resources. FIG. 4 is a schematic diagram showing a flow field distribution in an open water diversion channel according to the present embodiment. The right side of the channel is the main flow zone while the left side is the recirculation zone. A sloped channel penetrates through the side wall of the open channel to form the attraction channel, with an enclosed still water basin constructed where fishing devices or fish suction equipment are installed. A pump is added at the outlet of the attraction channel to extract attraction flow from the end of the open channel, forming a complete fish resource recovery system.

### Embodiment 4

The present embodiment represents an improvement over the above-mentioned embodiments and is a refinement of the above-described embodiments with respect to the attraction channel. The attraction channel described in the present embodiment has a slope gradient of less than 1:10, a width of less than 5 m, and a water depth of more than 0.5 m. The slope gradient of the attraction channel is related to the swimming capability of fish and should be determined based on the species, size, growth stage, swimming ability, and flow velocity preference of the predominant fish in the local environment. Data regarding fish swimming capability and flow velocity preference can be obtained from existing research or through laboratory experiments specifically conducted to study fish swimming performance and velocity preferences.

### Embodiment 5

The present embodiment represents an improvement over the above-mentioned embodiments and is a refinement of the above-described embodiment with respect to the attracted water flow. An attracted water flow rate described in the above-mentioned embodiment is 1/15 of the water flow rate in the open water diversion channel.

The attracted water flow rate should neither be excessively large nor too small, but rather appropriately matched with the water flow rate in the open water diversion channel. An excessively high-water flow rate would increase operational costs of the power plant's water intake system and reduce power generation efficiency, while an insufficient water flow rate would fail to establish the fish-attracting current penetrating from the recirculation zone to the main flow. In the present embodiment, the water flow rate through the attraction channel is set at 1/15 of the main intake flow. For example: when the water intake flow rate is 300 m³/s, the attraction channel water flow rate should be 20 m³/s. This configuration ensures minimal interference with normal operations of the open water diversion channel while achieving optimal fish attraction effectiveness.

### Embodiment 6

The present embodiment represents an improvement over the above-described embodiments and is a refinement of the above-described embodiments with respect to the release device. The release device described in the present embodiment is a fish guidance channel.

In order to protect the ecological environment, a special still water basin is provided at the outlet of the attraction channel, and a small channel is used as the fishway to guide the fish entering the still water zone to a position away from the open water diversion channel.

### Embodiment 7

The present embodiment represents an improvement over the above-described embodiments and is a refinement of the above-described embodiments with respect to the release device. The release device described in the present embodiment is a fishing trap. The fishing trap is installed in the still water zone to catch the fish trapped in the water area, and then the fish is manually transported to the natural waters far away from the open water diversion channel, so that the fish can survive. The fishing trap may be a fishing net, a fish pump, or the like.

### Embodiment 8

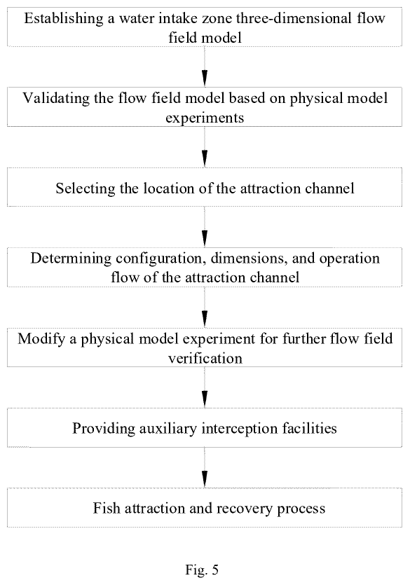

The present embodiment is an auxiliary method for fish resource recovery in an open water diversion channel using the facility for recovery described in the above embodiments. The steps of the method are as follows, and the flow chart is as shown in FIG. 5:
step 1: establishing a water intake zone three-dimensional flow field model: the water intake zone three-dimensional flow field model which includes the open water diversion channel is established, topography of the water intake zone, ambient flow conditions, shoreline characteristics, as well as the design dimensions, water intake flow rate, intake flow velocity, and intake depth of the open water diversion channel are is acquired, a water intake flow field model is established, computational grids are divided, boundary conditions and initial conditions for flow field simulation are determined, and appropriate computational parameters are selected to simulate flow field variations including the open water diversion channel and its affected water area; where the governing equations for flow field computation are as follows:

$$∇ \cdot u = 0$$

$$\frac{\partial u}{\partial t} + u \cdot ∇ u = - \frac{∇ p}{ρ} + \frac{1}{ρ} ∇ \cdot ( {μ}_{eff} ∇ u ) - \frac{2}{3} ∇ \cdot ( kI )$$

$$\frac{\partial }{\partial t} ( ρ k ) + ∇ \cdot ( ρ ku ) = ∇ \cdot ( {α}_{k} {μ}_{eff} ∇ k ) + {G}_{k} - ρε$$

$$\frac{\partial }{\partial t} ( ρε ) + ∇ \cdot ( ρε u ) = ∇ \cdot ( {α}_{ε} {μ}_{eff} ∇ ε ) + {C}_{1 ε} \frac{ε}{k} {G}_{k} - \frac{ρ {C}_{2 ε} {ε}^{2}}{k}$$

where u is a time-averaged velocity, t is time, p is pressure, ρ is water density, μ_{eff} is a turbulent effective viscosity, k is turbulent kinetic energy, I is second-order unit tensor, ox is a turbulent kinetic energy Prandtl number, ε is a turbulent dissipation rate, α_{ε} is a turbulent dissipation rate Prandtl number, Gₖ is a turbulent kinetic energy generation term caused by an average velocity gradient, and C_{1ε} and C_{2ε} are constant coefficients;
step 2: validating the flow field model based on physical model experiments: a corresponding geometrically scaled physical model indoors is constructed, and the flow velocity and direction are measured at characteristic cross-sections or points within the attraction channel, these measurements are compared with simulation results of the mathematical model for validation, where if the calculated values align well with the measured values, the established mathematical model can reflect basic characteristics of flow field distribution in the open water diversion channel, based on this, the location where fish resource recovery facilities are located in the open water diversion channel, as well as the water flow rate and configuration dimensions of the attracted water flow can be determined; The physical model established in the laboratory must comply with the following principles: it must satisfy the requirements of flow field similarity, and the inlet and outlet sections of the model must have sufficient transition zones to ensure similarity in inflow and outflow. The model design should prioritize gravity similarity while also considering requirements such as resistance similarity and buoyancy similarity of the water body. To ensure that the flow pattern of the model resembles that of the prototype, the Reynolds number of the model flow must be greater than the critical Reynolds number, ensuring the water body in the model enters the self-similarity region. Typically, a large-scale (1:100) normal physical model is adopted to primarily simulate the environmental flow and the flow field distribution within the open water diversion channel.

Depending on the varying environments around different power plants, open water diversion channels of various forms may be constructed along coastlines or riverbanks. To establish an effective attraction channel, a physical model can first be built to scale (or flow field distribution measurements can be directly conducted inside and outside the open channel). Subsequently, based on the data from the physical model or real-world measurements, a computer-simulated hydrodynamic mathematical model (flow field simulation model) can be developed. The flow field simulation is then performed and refined in the computer according to the physical model's flow field. The purpose of establishing the physical model and flow field simulation model is to determine the optimal locations for setting up attraction channels based on the flow field simulation results.

FIG. 4 illustrates a relatively typical flow field distribution of an open water diversion channel along a coastline (or riverbank). The open water diversion channel extends vertically from the shoreline into the sea, with the ocean current flowing perpendicular to the open channel. Thus, a 90-degree elbow is installed at the top of the channel, with its opening facing the direction of the ocean current. There are usually two kinds of environmental circulation, one is river bank, and the environmental flow is unidirectional, as shown in FIG. 4, from the right side of the figure to the left side of the figure. The other scenario involves coastline, where the environmental water flow is bidirectional, i.e., the direction of flow E alternates. In such reciprocating flow conditions, the flow field distribution in the straight section of the open channel is approximately similar.

As can be seen from FIG. 4, due to the 90-degree turn of the flow entering the open channel, a main flow zone forms on the right side of the open channel (with the downstream direction of the main flow defined as positive; the same applies hereafter; left and right are relative to the flow direction). The main flow zone exhibits higher flow velocities and a stable flow direction, making it unsuitable for the fish to linger. A recirculation zone is formed on the left side of the open channel. The flow velocity in the recirculation zone is relatively weaker, and fish with swimming capabilities, based on their preferential selection of flow velocity, tend to move toward areas with suitable flow conditions near the recirculation zone.

Step 3: selecting the location of the attraction channel: based on flow field distribution analysis and considering the swimming capabilities and behavioral characteristics of fish entering the open channel, in this case, small-sized fish such as Engraulis japonicus and Stolephorus commersonii, which possess moderate swimming ability (swimming speed >0.2 m/s), exhibit positive rheotaxis (preference for swimming against currents), and favor flow velocities of 0.2 to 1.3 m/s, the inlet of the attraction channel is positioned near the bank in the weak central region of the recirculation zone within the open channel (right side of the channel in FIG. 4), the outlet of the attraction channel is located outside the open channel in a near-bank area with low flow velocity and stable hydraulic conditions (still water zone). To prevent fish escaping from the still water zone and re-entering the open channel, a permeable barrier may be installed in this area. A controlled water flow rate (e.g., via pumps) is maintained at the outlet of the attraction channel, generating a transverse or near-transverse penetrating jet at the inlet that intersects perpendicularly with the main flow zone direction in the open channel. This jet serves to attract fish while creating an upstream-oriented, velocity-optimized environment (uniform still water zone) within the attraction channel, encouraging fish to actively swim toward the still water zone outside the outlet. The still water zone functions as a temporary holding area prior to release, where supplementary collection measures (e.g., fish pumps) are employed to transport fish out of the open channel, which effectively mitigates fish injury caused by water intake operations, thereby achieving resource conservation objectives.
step 4: determining configuration, dimensions, and attracted water flow rate of the attraction channel: based on flow field distribution analysis, combined with the swimming capabilities and behavioral characteristics of fish entering the channel, as well as the flow velocity and flow patterns within the attraction channel, the configuration, dimensions, and the attracted water flow rate of the attraction channel are comprehensively determined. The attraction channel is arranged at the outer side of the open water diversion channel and is in communication with the open water diversion channel, the inlet of the attraction channel is connected to one side wall of the open channel, and the attraction channel is configured such that the bottom is a chute with a sloped bottom, the lower end of the slope is inside the open water diversion channel, and the higher end of the slope is outside the open water diversion channel. The slope of the attraction channel (i.e., the chute with a sloped bottom) should not be more than 1:10, the width should not be more than 5 m, and the water depth should not be less than 0.5 m, and the length should be determined comprehensively according to the construction conditions of the power plant, and the length of the attraction channel in this example is 50 m. The outlet of the attraction channel is connected to a still water zone.

An attracted water flow rate is established at the outlet of the attraction channel, and a penetrating jet which flows vertically or nearly vertically to the main flow zone in the open channel is formed at the inlet of the attraction channel, and is used for attracting the fish to actively swim towards the attraction channel for the purpose of attracting the fish to accumulate therein.

The water flow rate of the attraction channel shall be selected based on fish species characteristics in the open channel environment, with primary consideration given to the capabilities of swimming against currents of several dominant fish populations; slope gradient of the attraction channel and the resulting flow velocity profile. The attracted water flow rate shall be optimized to effectively guide target fish species while accommodating their hydrodynamic adaptability.

That is, by setting an appropriate water flow rate for the attraction channel, a water flow velocity and flow pattern capable of attracting and attracting fish are established. Since the slope of the attraction channel is involved, it consequently affects the selection of the channel's location: the attraction channel is arranged on the right side of the open water diversion channel, near the shore area. This area is located within the recirculation zone on the right side of the open channel, while the outlet of the attraction channel is positioned in a still water zone formed between the side wall of the open channel and a coastal recirculation zone, as illustrated in FIG. 4.

Different open channel configurations and their surrounding environments may require different fish-attracting water flow rates, creating distinct flow fields in localized areas of the channel. Based on the flow field distribution formed by the elbow open channel and surrounding environmental flow shown in FIG. 4, as well as the arrangement of the attraction channel depicted in FIG. 1, a water flow rate of 20 m³/s can generate a penetrating attracted water flow through the recirculation zone, thereby attracting fish to the vicinity of the inlet of the attraction channel.

Step 5: modifying a physical model experiment for further flow field verification: according to the recommended attraction channel design proposed in step 4, the physical model in step 2 is modified by adding the attraction channel and a water supply system at the corresponding location in the channel, then conducting the physical model experiment to further study and analyze the flow field, and suitability of the fish resource recovery facilities is verified.

An attraction channel shall be constructed in the physical model, and fish attraction experiments shall be conducted based on predetermined parameters. Concurrently, hydrodynamic analysis shall be performed using the flow field simulation model to verify its suitability.

Step 6: providing auxiliary interception facilities: based on flow field analysis results in the channel, an auxiliary interception net is installed downstream of the inlet of the attraction channel in an area with relatively uniform and low-velocity flow, wherein the interception net spans the entire cross-section (i.e., spans from the water surface to the riverbed), encouraging fish to more easily find the inlet of the attraction channel while swimming along the net. The installation of the interception net primarily aims to facilitate rapid identification of the inlet of the attraction channel by fish. The flow direction near the inlet of the attraction channel shall create a counter-current environment, with flow velocities meeting the preference range of target fish species.

Step 7: fish attraction and recovery process: the attraction channel is activated, a jet flow from the recirculation zone to a main flow zone is created at the inlet of the attraction channel; fish's innate tendency to swim against currents and support of auxiliary facilities are utilized, the fish are guided in both the main flow and recirculation zones toward the inlet of the attraction channel, wherein the slope within the attraction channel generates a stable, uniformly graded reverse flow field, attracting fish to swim upstream to the still water zone at the outlet of the attraction channel, then the fish in the still water zone are released into natural waters outside the channel via the release device.

This step is the whole process of attracting and releasing, so that the main fish populations which are affected by water intake can be returned to the natural waters through the facilities, reducing the impact of water intake on fish resources, and playing a role in protecting the ecological environment.

Finally, it should be noted that the above description is intended to illustrate rather than limit the technical solution of the present invention. Although the invention has been described in detail with reference to preferred embodiments, those skilled in the art should understand that modifications (such as to the configuration of the open water diversion channel, the arrangement and shape of the attraction channel, the sequence of steps, etc.) or equivalent substitutions may be made to the technical solutions of the present invention without departing from the spirit and scope of the inventive technical solutions.

1. An auxiliary method for fish resource recovery in an open water diversion channel, wherein an auxiliary facility for fish resource recovery in the open water diversion channel is used for the auxiliary method, the auxiliary facility comprising: an inlet of the attraction channel arranged on a side wall of the open water diversion channel, a slope provided inside the attraction channel, wherein a lower end of the slope is located inside the open water diversion channel, and a higher end of the slope is located outside the open water diversion channel, an attracted water flow is arranged at the higher end of the slope to guide fish into the attraction channel and an outlet of the attraction channel is connected to a still water zone, wherein the still water zone is provided with a release device, an interception net arranged downstream of the inlet of the attraction channel; and the auxiliary method comprises the following steps:
step 1: establishing a water intake zone three-dimensional flow field model: establishing the water intake zone three-dimensional flow field model which includes the open water diversion channel, acquiring topography of the water intake zone, ambient flow conditions, shoreline characteristics, as well as the design dimensions, water intake flow rate, intake flow velocity, and intake depth of the open water diversion channel, establishing a water intake flow field model, dividing computational grids, determining boundary conditions and initial conditions for flow field simulation, and selecting appropriate computational parameters to simulate flow field variations including the open water diversion channel and its affected water area; wherein the governing equations for flow field computation are as follows:
$$∇ \cdot u = 0$$
$$\frac{\partial u}{\partial t} + u \cdot ∇ u = - \frac{∇ p}{ρ} + \frac{1}{ρ} ∇ \cdot ( {μ}_{eff} ∇ u ) - \frac{2}{3} ∇ \cdot ( kI )$$
$$\frac{\partial }{\partial t} ( ρ k ) + ∇ \cdot ( ρ ku ) = ∇ \cdot ( {α}_{k} {μ}_{eff} ∇ k ) + {G}_{k} - ρε$$
$$\frac{\partial }{\partial t} ( ρε ) + ∇ \cdot ( ρε u ) = ∇ \cdot ( {α}_{ε} {μ}_{eff} ∇ ε ) + {C}_{1 ε} \frac{ε}{k} {G}_{k} - \frac{ρ {C}_{2 ε} {ε}^{2}}{k}$$
wherein u is a time-averaged velocity, t is time, p is pressure, ρ is water density, μ_{eff} is a turbulent effective viscosity, k is turbulent kinetic energy, I is second-order unit tensor, αₖ is a turbulent kinetic energy Prandtl number, ε_{ε} is a turbulent dissipation rate, α_{ε} is a turbulent dissipation rate Prandtl number, Gₖ is a turbulent kinetic energy generation term caused by an average velocity gradient, and C_{1ε} and C_{2ε} are constant coefficients;
step 2: validating the flow field model based on physical model experiments: constructing a corresponding geometrically scaled physical model indoors, and measuring the flow velocity and direction at characteristic cross-sections or points within the attraction channel, comparing these measurements with simulation results of the mathematical model for validation, wherein if the calculated values align well with the measured values, the established mathematical model can reflect basic characteristics of flow field distribution in the open water diversion channel, based on this, the location where fish resource recovery facilities are located in the open water diversion channel, as well as the water flow rate and configuration dimensions of the attracted water flow can be determined;
step 3: selecting the location of the attraction channel: based on flow field distribution analysis and considering swimming capabilities and behavioral characteristics of fish entering the channel, locating the inlet of the attraction channel near a bank in a low-velocity area at the center of a recirculation zone where recirculation is relatively weak, wherein the outlet of the attraction channel is placed in a near-bank area outside the channel where the water flow is slow and stable, serving as a temporary holding area for fish before release;
step 4: determining configuration, dimensions, and attracted water flow rate of the attraction channel: based on flow field distribution analysis, combined with the swimming capabilities and behavioral characteristics of fish entering the channel, as well as the flow velocity and flow patterns within the attraction channel, comprehensively determining the configuration, dimensions, and the attracted water flow rate of the attraction channel;
step 5: modifying a physical model experiment for further flow field verification: according to the recommended attraction channel design proposed in step 4, modifying the physical model in step 2 by adding the attraction channel and a water supply system at the corresponding location in the channel, then conducting the physical model experiment to further study and analyze the flow field, and verifying suitability of the fish resource recovery facilities;
step 6: providing auxiliary interception facilities: based on flow field analysis results in the channel, installing an auxiliary interception net downstream of the inlet of the attraction channel in an area with relatively uniform and low-velocity flow, wherein the interception net spans the entire cross-section, encouraging fish to more easily find the inlet of the attraction channel while swimming along the net; and
step 7: fish attraction and recovery process: activating the attraction channel, creating a jet flow from the recirculation zone to a main flow zone at the inlet of the attraction channel; utilizing fish's innate tendency to swim against currents and support of auxiliary facilities, guiding the fish in both the main flow and recirculation zones toward the inlet of the attraction channel, wherein the slope within the attraction channel generates a stable, uniformly graded reverse flow field, attracting fish to swim upstream to the still water zone at the outlet of the attraction channel, then the fish in the still water zone are released into natural waters outside the channel via the release device.

2. The auxiliary method according to claim 1, wherein the direction of the attracted water flow forms an angle of 90 degrees or greater with the flow direction in the open water diversion channel.

3. The auxiliary method according to claim 2, wherein the open water diversion channel comprises two parallel side walls forming a straight channel section, a 90-degree elbow is provided at the end of the straight channel section, making the open water diversion channel inlet parallel to one side wall, the inlet of the attraction channel is arranged on the side of the recirculation zone in the open water diversion channel at a position 2-3 inlet widths away from the open water diversion channel inlet, and the attracted water flow perpendicular to the open water diversion channel can penetrate through the recirculation zone in the open water diversion channel.

4. The auxiliary method according to claim 3, wherein the slope gradient of the attraction channel is less than 1:10, the width should not exceed 5 m, and the water depth should not be less than 0.5 m.

5. The auxiliary method according to claim 4, wherein an attracted water flow rate is 1/15 of the water flow rate in the open water diversion channel.

6. The auxiliary method according to claim 5, wherein the release device is a fish guidance channel.

7. The auxiliary method according to claim 5, wherein the release device is a fishing trap.
